(19) United States
(12) Patent Application Publication
(10) Pub. No.: US 2015/0339887 A1
(43) Pub. Date: Nov. 26, 2015

(54) WAGERING SYSTEM AND METHOD

(71) Applicant: Station Casinos LLC, Las Vegas, NV (US)

(72) Inventors: Abraham Y. Hong, Las Vegas, NV (US); Jon R. Von Tobel, Las Vegas, NV (US); John F. Vidmar, Las Vegas, NV (US)

(73) Assignee: Station Casinos LLC, Las Vegas, NV (US)

(21) Appl. No.: 14/284,287

(22) Filed: May 21, 2014

(51) Int. Cl. G07F 17/32

(52) U.S. Cl. CPC G07F 17/3244

(57) ABSTRACT

Embodiments disclosed herein relate generally to a gaming system and method to allow a player to easily move from one type of gaming venue (table games, gaming machines, race/sports book) to another type of gaming venue (table games, gaming machines, race/sports book) without cashing out. Player's card balance, wagering account balance, WIN tickets or TITO vouchers are accepted interchangeably to establish a wagering credit in each of the types of gaming venues. A player may also wager electronically using a mobile device and print a TITO voucher using the mobile device and the kiosk to wager at another gaming venue.

### TECHNICAL FIELD

Embodiments disclosed herein relate generally to a wagering system and method for improving player wagering experience and gaming usage.

### BACKGROUND

Wagering has been popular for centuries. In more recent times, wagering establishments such as casinos have sought to improve the gaming experience for customers. In order to make the experience more rewarding, many gaming establishments have implemented user loyalty programs such as those successfully employed by airlines and other industries. Such programs allow a user to accumulate points based upon repeated purchases or utilization of the services of the provider. These programs improve user loyalty by allowing those users to redeem points earned by purchases to purchase other goods and/or services of the provider.

Gaming systems employing user loyalty programs have a central information network, which may be a wired or a wireless network, to which various devices, including gaming machines, are connected. Upon player loyalty card insertion, a player's activity may be tracked at the gaming machines during regular gaming sessions. Data is transmitted to the central authority for accumulating and tracking player points in a player account file in the central database. For example, upon insertion of a player card into a gaming machine, a session is established and reward points will accrue in the player's account depending upon various factors including the amount of money inserted into the machine during the gaming session or the amount of time the player spends wagering during the gaming session and the amounts that are wagered by the player.

As stated above, upon insertion of a player card into a gaming machine, for example a slot machine or video poker or other gaming machine, a gaming session is established and the player's identity is recognized by the computer reading the information from the player card. Once the player's identity is known, the network information software can track that player's use of the card in various machines and credit the player's account for player points earned during the player's visit to the gaming establishment. In this manner, the gaming establishment can track level and frequency of player activity during a gaming session as well as the number of gaming sessions and the amounts wagered during a particular calendar period. The history of the player's wagering, including both successful and unsuccessful wagers and associated won/lost amounts, may also be tracked.

The same player card may be used at other types of gaming activity in the gaming establishment. For example, the player card may be presented at the sports book counter when the player is wagering on sporting events and points can be accumulated by the player for that activity. As with the gaming machines, information on the player's frequency and level of activity, including won/lost information, may be useful to the gaming establishment. Points accumulated during this sports wagering activity is also valuable to the player as he or she may accumulate reward points which may be redeemed by that player to purchase additional gaming, meals or other discounted activities or merchandise which is offered by that gaming establishment to its customers.

Recently, sports wagering has become easier to access as wireless devices have been utilized to access sports book sites in which a player's wagering account may be accessed and odds viewed on particular sporting events. A player generally must establish a wagering account at the venue to avail him or herself of this electronic gaming opportunity. A wagering account is opened by the player at the gaming establishment by verifying his or her identity and funding the account by cash or various other means. A player is given an account number and PIN (personal identification number) at the time of opening the account to allow player access to the account. A player may select the type of event upon which he or she desires to place a wager and the amount of that wager may also be entered. This type of wagering permits a player to place a wager without waiting in line and without the need to be present at the sports book venue. For example, a player could be in another location in the gaming establishment playing a different type of game such as a gaming machine or a table game, and, using the wireless device, place a sports wager using an amount equal to, or less than, the balance in the player's wagering account.

A third type of wagering in a gaming establishment is generally known as table gaming. In this activity, games such as blackjack, craps, baccarat, roulette and the like provide a player with an opportunity to utilize luck and skill to wager money with a chance to win additional money. Generally, for table games, chips are used to make the wagers and winning bets are paid off in chips. The player's card may be presented at the time of purchase of the chips by the player and when the player is betting at the table game to accumulate points. Use of the card by the player also provides the gaming establishment with information on the frequency and level of a player's participation in this type of gaming activity during his or her visit to the casino. In more recent years, some gaming establishments and manufacturers have opted to introduce wagering methods for gaming machines which includes the ability to utilize bank credit or debit cards on those machines. For example, the player could proceed to the video poker area of the gaming establishment and utilize cash or a credit or debit card in an attempt to win additional dollars.

Some slot machines have used tickets generated by the machine to indicate a player gaming balance after concluding play on that machine. That is, upon ending the gaming session on that machine, a player may receive a voucher indicating the balance accrued during that session. For example, if a player inserts one hundred dollars by cash or credit card into the video poker machine and, upon terminating the gaming session, if, for example, the player has won an additional one hundred dollars, a balance of two hundred dollars may be indicated, while, if the player has lost fifty dollars in a wager, a balance of fifty dollars may be indicated on the ticket voucher. The ticket voucher may be exchanged at a cashier window or at a ticket redemption machine in the gaming establishment for cash. In these systems, the ticket voucher is not usable at another type of gaming venue.

While suitable for its intended purpose, the prior described systems limit players to wagering at one particular type of gaming venue or gaming machine without cashing out. That is, the ability of a player to easily and seamlessly move from one type of wagering such as gaming machines, to another type of gaming such as table games or sports wagering is limited. In those systems, if a player desires to change the type of gaming he or she participates in, that player must first cash out his or her account on the gaming machines and then take that cashed out balance to wager at another type of gaming such as the aforementioned table games or horse race or sports betting venue. In the event that a bank or other type of credit card is used to obtain cash and, for example, place a sports wager, the balance in the player's account at the gaming establishment is not visible to that player at the time the player wishes to make a wager.

An interactive kiosk is a computer terminal featuring specialized hardware and software designed within a public venue that provides access to information and applications for communication, commerce, entertainment, and education. Interactive kiosks sometimes resembled telephone booths, but can also be used while sitting on a bench or chair. Interactive kiosks are typically placed in high foot traffic settings such as hotel or casino lobbies or airports. Integration of technology allows kiosks to perform a wide range of functions, evolving into self-service kiosks. For example, kiosks may enable users to enter a public utility bill account number in order to perform an online transaction, or collect cash in exchange for merchandise. Customized components such as coin hoppers, bill acceptors, card readers and thermal printers enable kiosks to meet the user's specialized needs.

It would be desirable to have a gaming system which would permit a player to move from one type of gaming (machines, table games, sports wagering) to another type of gaming (machines, table games, sports/race wagering) seamlessly and easily and to minimize or eliminate the need to interact with cashiers or other personnel of the gaming establishment. It would be desirable to allow the player to redeem all or part of the balance on their account or voucher without visiting a cashier's cage. It would be desirable to have a gaming system in which a player could take a voucher from, for example, a gaming machine, which represents the balance in his or her gaming account or the credit after the gaming session on that machine, and use that voucher to wager at another type of gaming venue. The player may use the voucher to purchase chips in the case of table games or to place a wager on a sporting, horse race, or other event.

### SUMMARY

A wagering system and method is disclosed which permits a player to conveniently, easily, and quickly move from one type of wagering activity to another without the need to “cash out” or otherwise interact with a representative of the gaming establishment. For example, by utilizing a player card, wagering account, or gaming vouchers, a player may wager various amounts at various types of gaming seamlessly and without the necessity of visiting a cashier or, for example, a sports book attendant in the gaming establishment.

In one embodiment, the player may receive TITO (Ticket In Ticket Out) vouchers which indicate the amount of that player's winnings or other amounts at one gaming venue. These TITO vouchers can then be used at other types of gaming activities in the gaming establishment. For example, a player may receive a voucher from a wagering session at a slot machine and take that TITO voucher to a sports book venue to place a wager on a horse race, football game or other sporting event. As an illustration, a player could insert one hundred dollars into a slot machine and win an additional two hundred dollars and then decide to receive a voucher from that machine worth three hundred dollars representing his or her initial investment of one hundred dollars plus the two hundred dollars which that individual has won during the gaming session on that slot machine. The player may then proceed to another venue in the gaming establishment such as a sports book. In this embodiment, the player is permitted to make this change in venue and wagering activity without the need to redeem the voucher before proceeding to the sports book to place the wager. The player may present the voucher at the sports book and wager all or part of that three hundred dollars on a sporting event wager.

In another embodiment, the player may utilize his or her player's loyalty card to accumulate and place wagers in multiple venues in the gaming establishment. For example, the player's card could be inserted into a slot machine, video poker machine, or other type of automated gaming machine at the outset of the gaming session. The player may or may not insert cash into the machine at that time and receive a wagering credit on the card for that cash depending upon the existing balance on the player's card. The player may then accumulate his or her winnings while on that slot or other machine which is then credited to his or her account at the gaming establishment. The player may then proceed to a second type of gaming venue, for example a table game such as blackjack or roulette, and utilize the balance of his or her account as a wagering credit toward making wagers on that table game. In this embodiment, the player may also redeem the card at the table game venue for chips which may then be utilized to play the desired table game.

In another embodiment, a player may use a player wagering account to move from one type of wagering to another without cashing out any part of his or her account balance. For example, referring to the example described above, the player may move from wagering at a gaming machine such as a slot machine, to wagering at a sports book without redeeming the balance in his or her account. The user simply utilizes the account at the sports book venue to place a wager on a sporting event or other type of wagering event at that sports book. The amount of the wager is then deducted from the balance in the player's account when the wager is made. It should be noted that while the third type of wagering has been referred to as sports wagering such as football or horse racing, it does not have to be a sporting event per se as, for example, some sports books permit wagering on certain current events or other events for which betting odds have been established.

In another embodiment, a player may wager on a portable electronic device and receive an electronic indicia such as a TITO voucher representing a successful wager. The electronic TITO voucher may be displayed on the portable electronic device and the player may transport the electronic device to a gaming establishment. The electronic TITO voucher on the device may be read by a sensor at the gaming establishment and a hard copy TITO voucher may be issued and used at various gaming venues in the gaming establishment or it may be redeemed as a credit to a player wagering or loyalty account or at the gaming establishment for cash.

In order to facilitate the players movement from one venue to another, the embodiments disclosed herein describe a method and system whereby the player can utilize a voucher or credit from, for example, a slot machine, to play at another venue, for example, a baccarat table or a sports book, without redeeming (“cashing out”) his or her voucher at a cashier's cage in the gaming establishment. In alternate embodiments, a player may utilize the balance on his or her player's loyalty card or in his or her wagering account to make a wager at the desired different type of gaming venue.

### BRIEF DESCRIPTION OF THE DRAWINGS

FIG. 1 is a perspective view of a type of gaming machine venue;

FIG. 2 is a perspective view of a sports book venue at a gaming establishment;

FIG. 3 is a perspective view of a kiosk in accordance with one embodiment;

FIG. 4 is a perspective view of a wireless device which may be used in accordance with one embodiment;

FIG. 5 is a perspective view of a table gaming venue at a gaming establishment;

FIG. 6 is a block diagram of a network gaming system;

FIG. 7 is a flow chart of one embodiment of a gaming method using TITO and WIN tickets;

FIG. 8 is a flow chart of another embodiment of a gaming method using player accounts; and

FIG. 9 is a flow chart of a gaming method on a mobile electronic device.

### DETAILED DESCRIPTION

The disclosed embodiments include a wagering system and method which permits a player to move from one type of wagering activity such as, for example, gaming machines, to another, such as sports book betting, in a manner which reduces or eliminates the need to interact with a representative of the gaming establishment. The player may thus retain more privacy in his or her gaming activities. In addition, by permitting multiple types of ways for funding gaming activities, the system and method simplify, and thus make more convenient, the change in venue from, for example, gaming machines to sports betting to table games.

By utilizing a player card, wagering account, or gaming or ticket vouchers, a player may establish a wagering credit which permits that player to wager various amounts at various types of gaming seamlessly and without the necessity of visiting a cashier in the gaming establishment. A player may always use cash to fund a gaming session. However, in the event the player does not desire to carry large amounts of cash, or in the event the player does not wish to “cash out” by exchanging vouchers or tickets received from various gaming venues prior to proceeding to different venues, the method and system allows that player to use indicia received from one gaming venue in another gaming venue without the need to visit a cashier's cage or other location to exchange the tickets or vouchers for cash or other common currency. That is, indicia such as his wagering account or loyalty card as well as tickets or vouchers received after completion of a wagering session may be used at another gaming venue. The player may proceed directly from one gaming venue to another without any intermediate stops to cash out or otherwise obtain wagering currency.

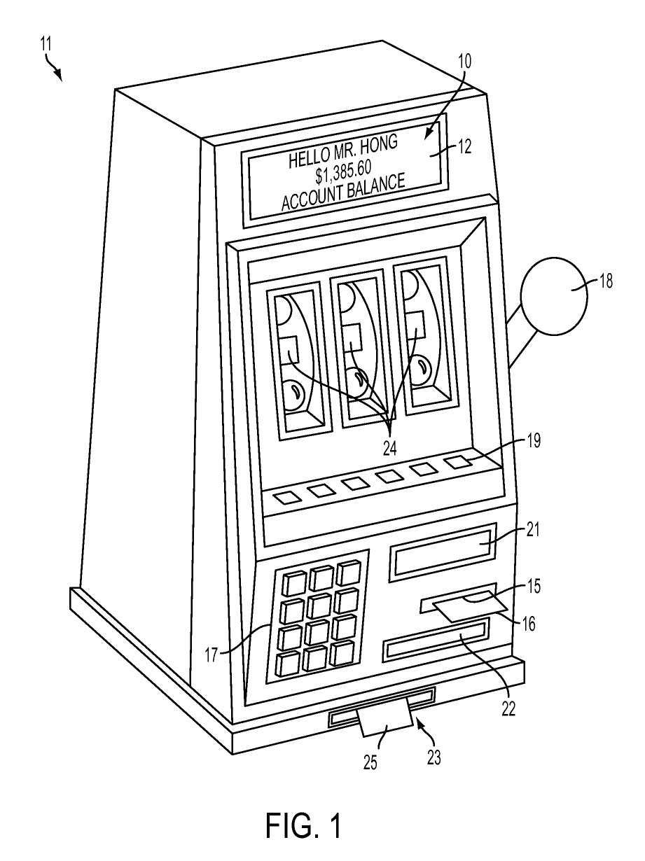

Referring to the figures wherein like reference numerals denote like structure throughout each of the various figures, FIG. 1 illustrates a first type of wagering system. In particular, a wagering machine 11 such as a slot machine is shown. Slot machine 11 includes a display screen 12 which, in one embodiment may include a touchscreen and may indicate information 10 which may include the name of the player, account number and that player's account balance. For reasons of privacy, a player may choose an option such that information 10 may or may not be displayed on screen 12. Slot machine 11 includes a magnetic card reader 15 into which a player loyalty card 16 may be inserted. Card 16 may be retained in card reader 15 until the gaming session is complete or card 16 may be swiped through card reader 15 such that the magnetic strip (not shown) on card 16 is read by card reader 15. Reading information from card 16 by card reader 15 provides the information displayed on display screen 12 including a balance remaining on the player's account. For security purposes, player 13 may be asked to input a passcode through the use of keypad 17. Player 13 may initiate play on slot machine 11 by pulling handle 18 or pressing betting keys 19 as is well known in the gaming art. In another embodiment, player 13 may log into his or her wagering account by entering the account number and PIN through touchscreen 12 or keypad 17.

In one embodiment, in order to make a wager on slot machine 11, player 13 may choose to input cash into bill validator/acceptor 21 or he or she may choose to wager from a TITO voucher 25 which, in one embodiment, may be inserted into bill validator 21. When cash is inserted into bill validator/acceptor 21 or a TITO voucher is inserted into validator 21, the amount inserted is reflected on screen 12 at account balance information 10. In another embodiment, player 13 may choose to place a wager by drawing from the account balance indicated on screen 12 which is read from card 16 by magnetic card reader 15. In yet another embodiment, player 13 may log into his or her wagering account by inputting the account number and a personal identification number (PIN) through keypad 17 or a touchscreen 12 if the machine is so configured. In another embodiment, player 13 may elect to wager by inserting a WIN ticket 34 (as described below) into optical mark recognition device 22. In any event, player 13 makes a wager and plays slot machine 11 by pulling handle 18 or pressing wagering buttons 19 depending upon the type of slot machine or the player's preference. Upon playing slot machine 11, the amount of the wager is deducted from the chosen account or wagering credit and the matching icons visible in windows 24 indicate whether player 13 has won or lost the wager as is known in the gaming art.

If the player 13 has won the wager, then the amount of the winning wager is displayed on screen 12 and reflected as an addition to wagering credit information 10. Thus, the player 13 may continue to play as long as there is a sufficient balance shown on screen 12 to support the amount of the wager desired. Of course, additional amounts may be added to the player's account through cash, TITO voucher 25, WIN ticket 34 or other means in accordance with the embodiment. When player 13 has determined to end the gaming session, he or she may depress one of buttons 19 designated for that purpose or input an instruction through keypad 17 in order to end that gaming session.

In one embodiment, ending the gaming session by player 13 results in indicia that the account balance is being retained in the player account information 10 as reflected on screen 12. As will be discussed below, the player may then use that balance at another gaming machine or at another type of gaming in the gaming establishment. In another embodiment, ending of the gaming session by player 13 may result in the dispensing of indicia such as a TITO voucher 25 at ticket printer 23 depending upon player preference. In this embodiment, the amount of the account balance 14 on screen 12 is reflected on TITO voucher 25. As will be further discussed below, TITO voucher 25 may be used at another gaming machine in the gaming establishment or at another type of gaming venue in that gaming establishment or in a gaming venue at another geographically remote gaming establishment.

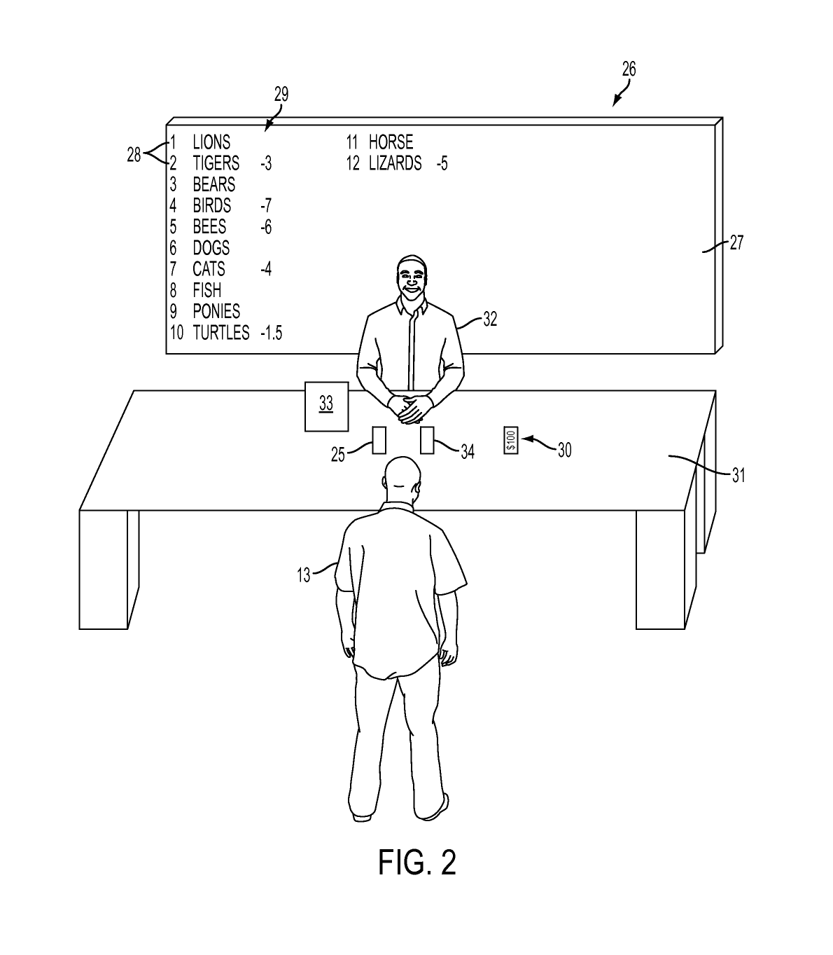

Referring to FIG. 2, a second type of gaming venue is illustrated. This type of gaming is commonly referred to as a sports book 26 for wagering on sporting or other events as determined by the gaming establishment. Sports book 26 generally includes a display screen 27 for indicating the teams playing 28 and the odds or point spreads 29 for that game. As an example, the Lions may be playing the Tigers in a football game with the Tigers favored by 3 points as shown in FIG. 2. In order to place a wager, player 13 approaches counter 31 and indicates to sports book employee 32 which wager he or she desires to make. In the case of the Lions and Tigers game example, player 13 states to sports book employee 32 that he wishes to wager on #2 (Tigers) for one hundred dollars. Sports book employee 32 then enters this information in terminal 33 and takes the amount of the wager, a one hundred dollar bill 30, from player 13. Sports book employee 32 issues a sports and race wagering ticket from a tote which, in one proprietary system, may be known as a WIN (Wagering Information Network) tote to issue WIN ticket 34 to player 13 indicating that a wager in the amount of one hundred dollars has been made on the Tigers and 3 points is being given to the Lions in that game.

In another embodiment the disclosure, player 13 gives sports book employee 32 a player loyalty card 16 which sports book employee 32 inserts into terminal 33 and which is read in terminal 33 as described above with respect to slot machine 11. The one hundred dollar amount of the wager on the Tigers placed by player 13 is deducted from player 13's card balance. In another embodiment player 13 hands sports book employee 32 a TITO voucher 25 which player 13 had received from slot machine 11 in the embodiment described with respect to FIG. 1 above. In another embodiment, player 13 (or employee 32) logs into player 13's wagering account by entering the wagering account number and PIN in terminal 33 to fund the wager. In any of these embodiments, player 13 receives a WIN ticket 34 indicating the wager (#2 Tigers) and the amount of the wager (one hundred dollars) as was described above when player 13 handed cash to sports book employee 32. Thus, the transition of player 13 from playing one type of gaming (slot machines) to another type of gaming (sports book) is seamless and results in greater convenience to player 13 as different types of funding the wager may be used. As will be discussed below, WIN ticket 34 may also be redeemed at different types of gaming venues in the gaming establishment.

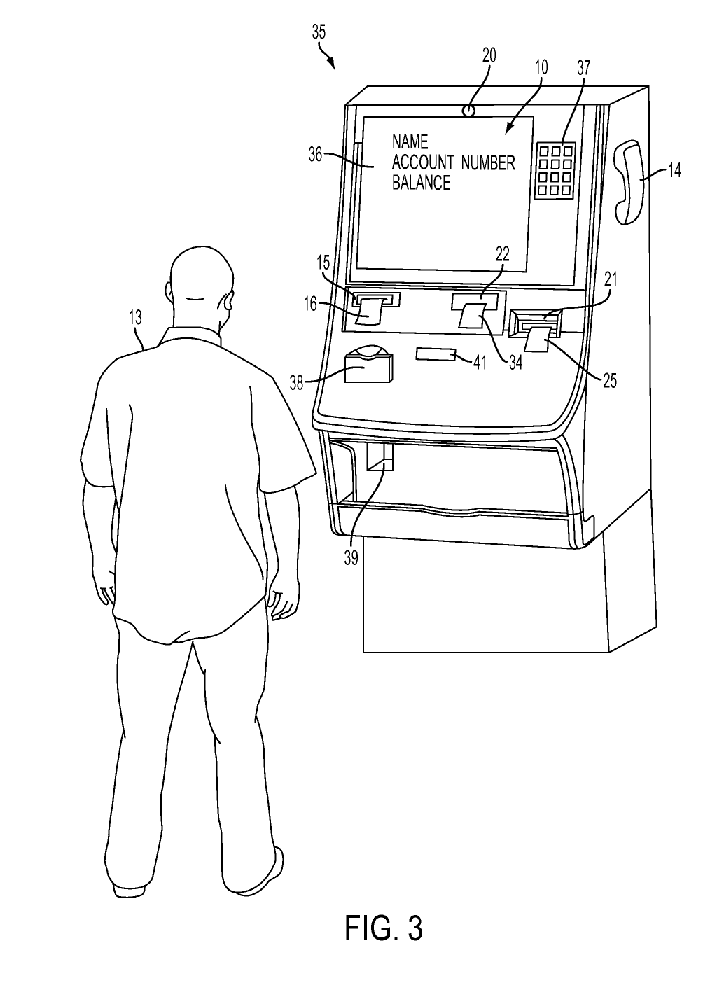

In another embodiment, referring to FIG. 3, player 13 may wager at a sports book by utilizing a standalone kiosk 35. Kiosk 35 may be positioned at various convenient locations throughout the gaming establishment. Kiosk 35 is connected through a network to a central computer as is slot machine 11 in FIG. 1 such that the same information is available at kiosk 35 as at screens 27 in FIGS. 2 and 12 in FIG. 1. As with the live sports book described in FIG. 2, kiosk 35, in one embodiment, accepts player card 16 in magnetic card reader 15. The information on the magnetic strip of card 16 is read by reader 15 and the player information 10 such as name, account number, point balance and account balance may be displayed on screen 36, which may be an interactive touchscreen as in FIG. 1 or player 13 may elect not to have such information 10 displayed for reasons of privacy. Player 13 may insert card 16 into card reader and enter the passcode or other security measure on keypad 37 or touchscreen 36 to log into player 13's account. Player 13 may then use a keypad 37 to select a wager (#2 Tigers) as was done in the embodiment shown in FIG. 2. As with the embodiments described with respect to FIG. 2, player 13 is issued a WIN ticket 34 from printer 41 indicating the wager (#2 Tigers) and the amount of the wager (one hundred dollars).

In an alternate embodiment, referring again to FIG. 3, player 13 may use a TITO voucher 25 received from another type of gaming such as a slot machine 11 described in FIG. 1 or received from another kiosk 35 at another location in the gaming establishment. Voucher 25 is inserted into bill validator 21 as was described above with respect to slot machine 11 in FIG. 1. If player 13 has a WIN ticket 34 from a successful sports book wager, he or she may insert that WIN ticket 34 into an optical mark recognition (OMR) device 22 to establish a wagering credit. In another embodiment, player 13 may enter his wagering account number and PIN number into kiosk 35 either through keypad 37 or touchscreen 36. Of course, player 13 could insert cash into bill acceptor 21 as was also described with respect to FIG. 1 to establish a wagering credit. Whichever funding method is chosen, as with the embodiments described in FIG. 2 and in the previous paragraph, player 13 is issued a WIN ticket 34 from printer 41 indicating the wager (#2 Tigers) and the amount of the wager (one hundred dollars).

Kiosk 35 may also include the ability to accept coins in coin acceptor 38 and to dispense coins from coin dispenser 39. Kiosk 35 may include the ability to dispense cash through bill validator 21 and coin dispenser 39 such that player 13 may choose to withdraw all of some of the balance of his or her account at any time. Player 13 may also choose to add cash to fund his or her account through bill acceptor 21 and coin acceptor 38. Kiosk 35 includes the ability to incorporate utilization of ticket-in/ticket-out (“TITO”) vouchers 25 or WIN tickets 34. Player 13 will be able to establish a wagering credit with cash, from his loyalty card 16, from his wagering account or with WIN tickets 34 or TITO vouchers 25, and add/withdraw monies to/from his or her account using kiosk 35. Kiosk 35 also allows player 13 to interact with a remotely located solution center employee of the gaming establishment through video/still camera 20 and telephone handset 14 on kiosk 35. Printer 41 may also issue gaming rules and regulations or other materials as deemed necessary or advisable by the gaming establishment.

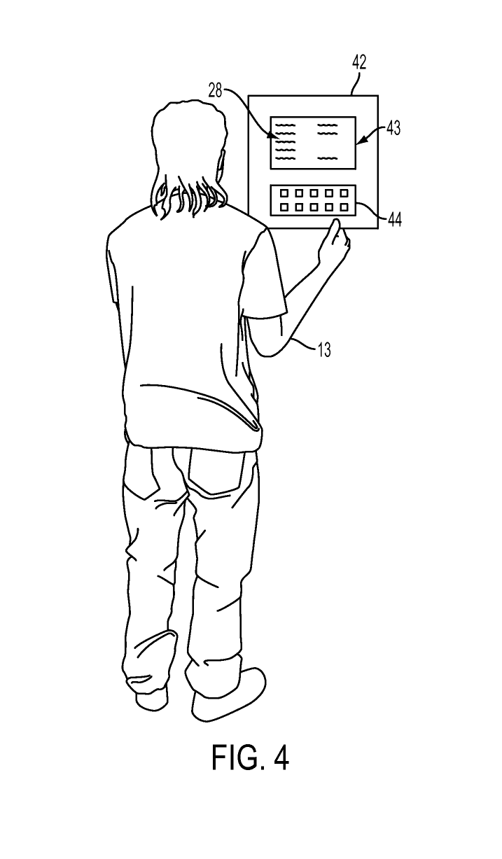

Referring to FIG. 4, in another embodiment a remote wireless handheld device 42 is shown. Player 13 may access the sports book betting operations in a gaming establishment through an internet or intranet connection. Device 42 may display information 28 on screen 43 identical to that displayed on screen 27 in FIG. 2. After player 13 has accessed his or her wagering account through device 42 by entering account number and PIN number through keypad 44 or touchscreen 43, player account information such as information 10 may be accessed and displayed on screen 43. Player 13 may also then input his or her wagering information through keypad 44 or touchscreen 43. In this embodiment, player 13 is not issued a hard copy of a WIN or TITO ticket. Rather, all debits and credits to his or her wagering account are made electronically through the gaming establishment network. However, in one embodiment, a TITO ticket may be electronically displayed on screen 43 to indicate the wagering amount in his or her account and/or as a result of a particular wager. This electronic TITO ticket may later be scanned on kiosk 35 by electronic scanner 21, screen 36 or another device which has the ability to read electronically displayed data information 28 displayed on screen 43. The electronic TITO ticket may then be printed by printer 41 at kiosk 35. As with the other embodiments described herein, player 13 may also access his or her account through kiosk 35 and make additions or withdrawals to his or her account as is described herein.

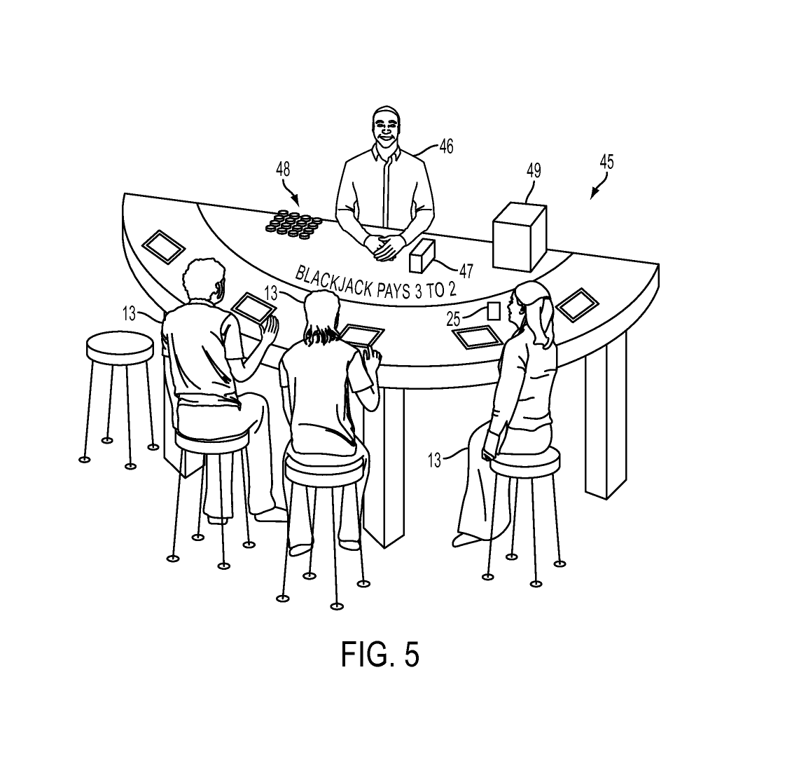

A distinctive feature of the embodiments described herein is the manner in which multiple types of gaming such as, for example, race/sports, table game, and slot players will be brought closer together. By expanding the options in which players can interact with slot machines 11 (or other gaming machines such as video poker and the like) and sports books (FIG. 2) and table games (FIG. 5) via TITO instruments 25, WIN tickets 34, wagering accounts and player card 16, players 13 will have a convenient and enriched entertainment and wagering experience. Players 13 are provided with a distinctive and convenient way to establish a wagering credit and thus to wager in a near cashless manner across multiple types of gaming venues.

Kiosk 35 provides flexibility of remote placement and 24/7/365 self-service to give the player 13 around-the-clock-access for sports book wagering to improve player convenience and the accessibility of the gaming establishment. In addition, players 13 will not be impacted by hours of operation in the sports book nor long lines at race and sports book counter 31. Kiosk 35 accepts funded sports wagers from rated, and unrated/anonymous players. A rated player is one who has established a loyalty account. A rated player must have a loyalty card account in order to establish a wagering account. An unrated/anonymous player has neither a loyalty account nor a wagering account. Kiosk 35 accepts: (i) cash in bill validator 21 and coin acceptor 38; (ii) TITO instruments 25 in bill validator 21; or (iii) successful WIN tickets 34 in OMR 22 as a means to establish a wagering credit and thus fund desired wagers and/or to add funds to an existing wagering account. Kiosk 35 also allows access to wagering accounts and loyalty card accounts. Thus, account withdrawals or deposits can also be initiated at the kiosk 35. The players are able to add funds to their wagering or loyalty account by inputting cash, TITO instruments and WIN tickets into the kiosk 35. Winning account wagers may be paid directly to the player's loyalty or wagering account or in TITO vouchers 25.

In one embodiment, kiosk 35 includes a self-service sports book which provides benefits to both players and the sports book venue 26. Players enjoy wagering freedom to easily move from playing slot machines to sports book wagering to table game wagering. TITO vouchers 25 and WIN tickets 34 are usable at the kiosk 35 and over-the-counter in the sports book 26 and at table games to establish a wagering credit at the venue allowing player 13 to place wagers. Similarly, player's loyalty card accounts and wagering accounts are available at all three types of venues to establish a wagering credit and thus fund wagers. In one embodiment kiosk 35 may or may not dispense cash, but TITO vouchers 25 and WIN tickets 34 can be redeemed for cash or credit in ticket redemption machines and at a cashier cage on the gaming establishment premises. TITO vouchers 25 and WIN tickets 34 can also be used to fund a player's wagering or loyalty card account through kiosks 35 or at other locations on the gaming establishment premises.

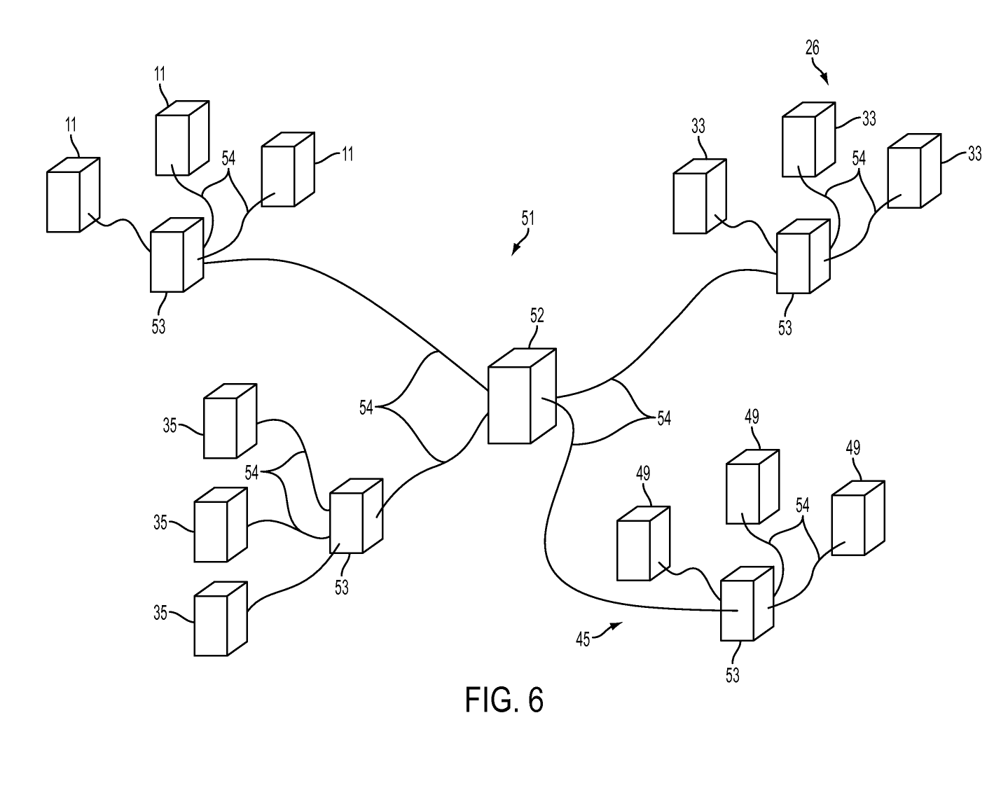

Referring to FIG. 5, in another embodiment, a table game such as, for example, a blackjack table venue 45, may be played by players 13. A dealer 46 deals cards 47 and the well-known blackjack game may be played. For this type of wagering, chips 48 are used to fund wagers. In this embodiment, chips 48 may be purchased from dealer 46 using cash or, in one embodiment, TITO vouchers 25 or WIN tickets 34 may also be used to purchase chips 48 from dealer 46. Dealer 46 may access terminal 49 which is connected via gaming establishment network (FIG. 6) to a central computer. In this embodiment, player 13 gives cashier 32 a TITO voucher 25, WIN ticket 34 or player card 16 which dealer 46 inserts into terminal 49 and which is read in terminal 49 as described above with respect to slot machine 11 and kiosk 35. Player 13 may also access his or her wagering account, or permit dealer 46 to do so, by entering wagering account number and PIN through terminal 49 to fund a chip purchase. Dealer 46 then gives player 13 an amount of chips 48 requested by the player equal to or less than the amount of the gaming credit as determined by TITO voucher 25, WIN ticket 34, wagering account or player card 16. Thus, player 13 may easily move back and forth from any one of three types of gaming venues (FIG. 1, 2, or 5) utilizing TITO vouchers 25, WIN tickets 34, a wagering account, or player's loyalty card 16 and avoiding using cash to fund his or her wagers in those venues. After completing his or her gaming session at gaming venue 45, player 13 may receive a TITO voucher 25 from dealer 46 representing the remaining dollar amount of chips in that player's possession at the end of the gaming session or the player may choose to have his or her wagering account or players loyalty account credited with the dollar amount of the remaining chips. While blackjack has been disclosed as a table game venue, it can be appreciated that other types of table games such as craps, roulette, baccarat, poker and the like may utilize the disclosed embodiments.

Referring to FIG. 6, a gaming establishment computer network 51 is illustrated. Network 51 may include a central computer or server 52. Server 52 is connected to various routers 53 by network connections 54 which may be wired, wireless, optical or other electromagnetic connections as is known in the art. Routers 53 could also include additional computers as is known to one skilled in the networking arts. Each of the four areas surrounding server 52 represents a type of gaming venue or, as in the case of kiosk 35, may function as both a sports book and a kiosk. Gaming machines 11, which may be slot machines or video poker machines or other types of gaming machines, are electromagnetically connected at 54 to router 53 which is, in turn, connected through network connections 54 to server 52. While three gaming machines 11 are shown in FIG. 6, it should be expressly understood that any number of machines 11 could be connected within the network 51 as is known in the network design art. It may also be possible to connect machines 11 directly to server 52 and eliminate router 53. As with the connections from router 53 to server 52, connections 54 could be any type of electromagnetic connection as is known in the art.

Similarly, in table games venue 45, terminals 49 are connected through 54 to a router 53 which is in turn connected through connections 54 to server 52. As with the gaming machines 11, while only three terminals 49 are shown, any number of terminals consistent with network design parameters may be employed and connections 54 may be any type of electromagnetic connection. In sports book venue 26, terminals 33 are similarly connected through connections 54 to router 53 and in turn to server 52. Continuing to refer to FIG. 6, kiosks 35 are similarly connected through 54 to router 53 and server 52 as is described above. The cashier's cage in the gaming establishment may also be connected to this network through terminals such as terminals 33 and 49 at the sports book and table games venues described above.

In operation, this system shown in FIG. 6 permits a player to wager at any one of venue types 11, 26, 45 or 35 easily and seamlessly using player card 16, a wagering account, TITO voucher 25, or WIN ticket 34. Server 52 tracks the balance of the player 13 wagering account. Gaming machines 11, terminals 33 or 49, or kiosk 35 read player card 16, player wagering account number and PIN, TITO voucher 25, or WIN ticket 34 and determine the balance remaining on TITO voucher 25 and in the player 13 account if card 16 or wagering account is used. In this manner, both player 13 card and/or wagering account and any award points may be tracked. As described above, the gaming establishment may also track the player 13 usage from a frequency, amount wagered, duration, and win/loss standpoint in order to provide better and more efficient services to that player 13.

While, FIG. 6 was illustrated with respect to one gaming establishment and multiple venues within that establishment, it should be expressly understood that the network shown in FIG. 6 could be expanded to multiple gaming establishments without departing from the scope of the disclosure. Server 52 could be located in a central location separately from, or on one of, the multiple gaming establishments and/or one or more of each of venues 11, 26, 45 and 35 could be located in one or more remote gaming establishments such that player 13 could play gaming machines 11 in multiple geographic locations using player card 16, wagering account, TITO voucher 25 or WIN ticket 34. Referring to FIG. 4, player 13 may be permitted to access network 51 wirelessly by accessing his or her wagering account through mobile device 42.

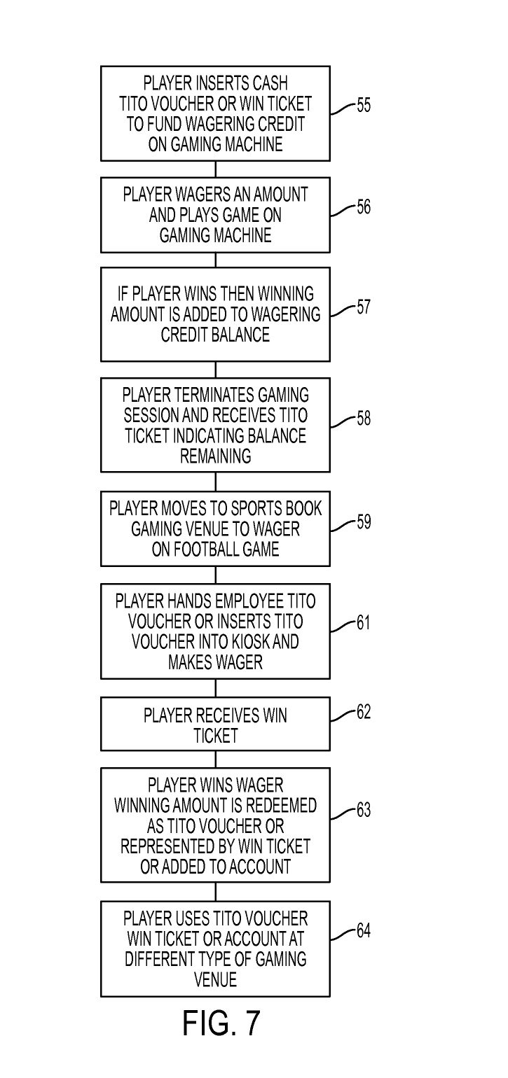

Referring to FIG. 7, a flow chart illustrating one embodiment of the disclosure is shown. In this embodiment, cash, WIN tickets 34 and TITO vouchers 25 are used to establish wagering credits at different venues in the gaming establishment. In step 55, a player enters a gaming establishment and funds a wager at a first type of gaming venue as, for example, a slot machine. The wager is funded using cash, TITO voucher 25 or a winning WIN ticket 34 which the player has received as a result of a previous sports book wager. The player makes a wager at step 56 equal to or less than the amount inserted at step 55 and the amount of the wager is deducted from the wagering credit and player 13 plays slot machine 11. Upon playing the game, the player either wins or loses the wager at step 57 and if player 13 wins the amount is added to the wagering credit balance on the gaming machine. The player may continue to play making multiple wagers by repeating steps 56 and 57 as many times as desired. When the player decides to terminate the gaming session in step 58 at the slot machine he or she receives indicia indicating the remaining credit balance on the machine based upon the original amount inserted at step 55 and the winning or losing amounts accumulated at steps 56 and 57. Indicia may take the form of a TITO ticket voucher 25 in one embodiment.

After terminating his or her play at step 58, the player may move to a different type of gaming venue such as the sports book at step 59 to place a wager on a football game. In step 61, if the player is at a live sports book he or she presents the TITO voucher 25 to the cashier who then inserts the TITO voucher into a terminal 33 to read the value of the TITO voucher which may establish a wagering credit or may, if the player 13 chooses, be added to the player's wagering or loyalty card account. In one embodiment, instead of the cashier inserting the TITO voucher 25, the player may insert the voucher directly into the terminal 33. If the player is placing the sports book wager at a self-serve kiosk 35 as described above, then the player inserts the TITO voucher 25 into kiosk 35. The player may receive a WIN ticket 34 from kiosk 11 memorializing his or her wager at step 62. For example, in the event a wager is made on the Tigers for one hundred dollars as described above with respect to FIG. 5, then a WIN ticket 34 may state a wager on #2 Tigers minus 3 points as described above.

Depending upon the outcome of the wager made at step 61, the player may win or lose and, if he wins, the player may redeem the amount indicated on the WIN ticket 34 as a TITO voucher, in cash, or player 13 may retain the WIN ticket 32 to establish a wagering credit at another gaming venue. If player 13 has a wagering and loyalty account, he or she may choose to add that amount to either of such accounts in step 63. If the wager is placed on a short term event like a horse race then the player may remain in the sports book area but, if the event is a future sporting or race event, the player may leave the area with the WIN ticket 34. When the player determines to redeem the WIN ticket 34 either shortly after a short term (e.g. horse race) or longer term (e.g. football game) wager then at step 64 the player may receive a TITO voucher in the amount which is determined based upon the beginning value in step 61 and the amount won or lost in the sports book wager at step 62 or the player may choose to add such amount to his or her account as discussed above in step 63 or the player may choose to retain the WIN ticket 34 to use at another wagering venue.

As with the previously described embodiments, the player may use TITO voucher 25 to place another wager at the same type of gaming venue or he or she may proceed to another of the gaming venues such as a gaming machine or a table game. Also as previously stated, in the circumstance where the types of gaming venues are networked between gaming establishments in diverse geographic locations, the player could proceed to another of those geographic locations in order to place a wager at the same or a different type of gaming venue. In one embodiment, player 13 may take the winning WIN ticket 34 to another venue and use that amount to fund a wager at that venue as described above.

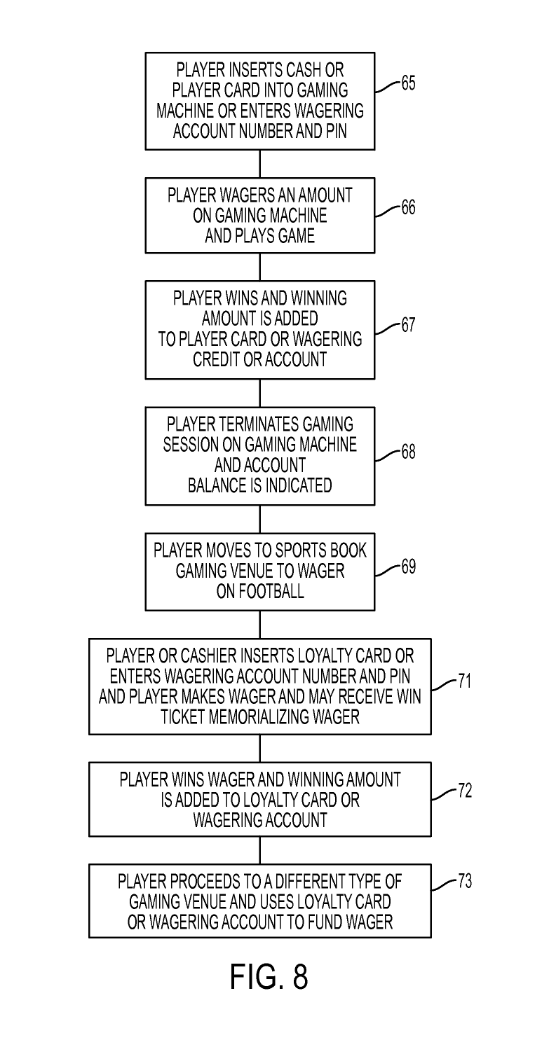

Referring to FIG. 8, a flow chart illustrating another embodiment of the disclosure is shown. In step 65, a player enters a gaming establishment and funds a wager at a first type of gaming venue as, for example, a slot machine 11. The wager is funded using a wagering credit established by cash or a player loyalty card 16 or the player's wagering account if that player is a rated player who logs on with the wagering account number and PIN. As with the embodiment described in FIG. 7, the wagering credit could also be established by a TITO voucher 25 or successful WIN ticket 34. The player makes a wager at step 66 equal to or less than the wagering credit amount and plays the slot machine 11. Upon playing the game, the player either wins or loses the wager at step 67 and, in the event of a win by player 13, the amount is added to the wagering credit or, if a rated player, then a loyalty card account or wagering account 16. The player may continue to play making multiple wagers by repeating steps 66 and 67 as many times as desired. When the player decides to terminate the gaming session in step 68 at slot machine 11, his or her wagering credit or player loyalty card or wagering account balance is based upon the initial wagering credit balance and winning or losing amounts accumulated at steps 66 and 67.

After terminating his or her play at step 68, the player may move to a different type of gaming venue such as the sports book 26 at step 69 to place a wager on a football game, horse race or other sporting event. In step 71, if the player is at a live sports book 26 he or she presents the player loyalty card 16 to the sports book employee 32 who then inserts the player card into a terminal 33 to read the value in the player's account. In one embodiment, instead of the sports book employee 32 inserting the player card 16, the player may insert the card 16 him or herself into the terminal 33. If player 13 is also has a wagering account, he either inputs, or has the employee 32 input, his wagering account number and PIN to log onto the wagering account. If the player is placing the sports book wager at a self-serve kiosk 35 as described above, then the player inserts the player loyalty card 16 into the kiosk 35 and may also log into his wagering account using the account number and PIN. The player may receive a WIN ticket 34 memorializing his or her wager from kiosk 35. If player 13 is wagering from a wagering or loyalty card account, he may choose not to have a WIN ticket issued as the wager is memorialized in the players wagering or loyalty card account. For example, in the event a wager is made on the Tigers for one hundred dollars as described above with respect to FIG. 5, then a WIN ticket 34 may state a wager on #2 Tigers minus 3 points as described above or that wager will be listed in the player's loyalty or wagering account and may be accessed on kiosk 35.

Depending upon the outcome of the wager made at step 71, the player may win or lose and, if the player wins, the player may redeem the amount indicated on the WIN ticket 34 in the form of a TITO voucher 25 or the amount may be added to the player loyalty card or wagering account in step 72, or, as described above, the successful WIN ticket may be used at another venue. In one embodiment, player 13 may receive cash from kiosk 35 representing all or part of player's loyalty or wagering account balance. If the wager is placed on a short term event like a horse race then the player may choose to remain in the sports book area to watch the event but, if the event is a future event, the player may choose to leave the area with the WIN ticket 34. If the player has received a WIN ticket, then the player may redeem a successful WIN ticket for cash or use at another venue either shortly after a short term (e.g. horse race) or longer term (e.g. football game) wager. Horse race and sports WIN tickets may be valid for a predetermined period of time after the event. If the player has chosen not to receive a WIN ticket, then the player's loyalty card or wagering account may be credited at the time of a successful wager in the amount which is determined based upon the amounts won in the sports book wager at step 72. In another embodiment, at step 73, the amount won at step 72 may be received in the form of a TITO voucher 25 which may be used at other wagering venues.

As with the previously described embodiments, the player may use the TITO voucher 25, winning WIN ticket 34, player's loyalty card 16, or wagering account to fund a wagering credit and place another wager at the same type of gaming venue or he or she may proceed to another of the gaming venues such as a gaming machine 11 or a table game 45. Also as previously stated, in the circumstance where the types of gaming venues are networked between gaming establishments in diverse geographic locations, the player could proceed to another of those locations in order to place a wager. While FIG. 7 has been described with respect to wagering from TITO vouchers 25 and WIN tickets 34 and FIG. 8 from wagering or loyalty accounts, it should be expressly understood that player 13 may utilize any of these types of means to establish a wagering credit and place a wager.

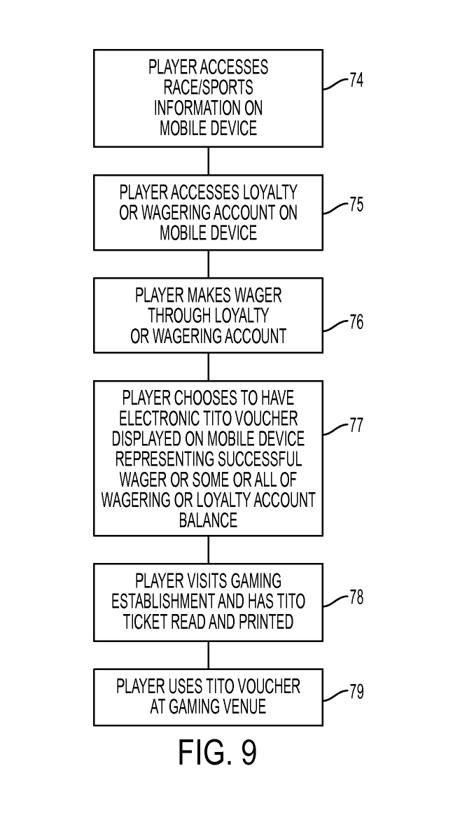

Referring to FIG. 9, a flow chart illustrating another embodiment of the disclosure is shown. In the mobile wagering embodiment shown in FIG. 4, at step 74 player 13 displays race and sports book betting information 28 from a gaming establishment on his or her mobile device 42 such as a smartphone, tablet or laptop computer. Player 13 may then decide to make a wager and at step 75 he or she then accesses his or her wagering or loyalty account through device 42 by entering account information on keypad 44 or touchscreen 43. In one embodiment these steps are combined such that, by accessing a wagering or loyalty account, the race and sports book wagering information 28 is displayed as part of the account information. At step 76, player 13 may then make a wager as if he or she were at a race/sports book as is described with respect to FIG. 2 above. This wager is stored as part of player 13's wagering or loyalty account. In one embodiment, at step 77, player 13 may choose to have a TITO voucher displayed electronically on screen 43. Player 13 may choose to have the amount of a successful wager from step 76 or may elect to have all or part of his or her balance in a wagering or loyalty account represented on the displayed electronic TITO information. At step 78, player 13 may then visit a gaming establishment and have the electronic TITO voucher read from screen 43 by optical scanner reader 22 and printed by printer 41 on kiosk 35 or have the electronic TITO voucher read and redeemed for cash. Of course, other locations at the gaming establishment such as cashier's cages and ticket redemption centers may also have the capability to read electronic TITO voucher from screen 43 and issue a hard copy TITO voucher 25 or cash. At step 79, player 13 may then use TITO voucher 25 to establish a wagering credit at another gaming venue in the gaming establishment as described above.

While the disclosure has described various embodiments, it should be expressly understood to those of ordinary skill in the art that certain modifications may be made without departing from the spirit or scope of this disclosure. For example, while various network configurations and connections have been disclosed it should be understood that alternate configurations and connections may be employed without departing from the spirit or scope of the disclosure. Accordingly, the proper scope of this disclosure is set forth in the following claims.

1. A method for placing a wager in one of a plurality of gaming venues said method comprising the operations of:
establishing a first wagering credit at a first type of gaming venue, through a first device associated with a gaming establishment network, and using
a winning sports and race wagering ticket;
receiving indicia selected from the group consisting of a TITO voucher, a wagering account credit, and a loyalty account credit, the receipt occurring after establishing said first wagering credit and without placing a wager at said first gaming venue;
using said received indicia to establish a second wagering credit at a second type of said gaming venue through a second device associated with the network, said second device includes a card reader and a bill validator for reading said received indicia, said second type of gaming venue being different from said first type of gaming venue; and
placing a wager at said second gaming venue using said second wagering credit; wherein:
the first gaming venue is chosen from the group consisting of a gaming machine, a table game, a standalone machine on a gaming floor, and a sports book;
the second gaming venue is chosen from the group consisting of a gaming machine, a table game, a standalone machine on a gaming floor, and a sports book; and
said first device includes a sports and race wagering ticket acceptor.

2. The method of claim 1 further including;
receiving further indicia selected from the group consisting of a second TITO voucher, a sports and race wagering ticket, a second wagering account credit, and a second loyalty account credit after said wager; and
using said further indicia to place a wager in a third type of gaming venue, said third type of gaming venue being different from said second type of gaming venue.

3. A system for placing a wager in one of a plurality of types of gaming venues selected from among the following: gaming machines; table games; and race/sports book; said system comprising:
a gaming establishment network;
a first gaming apparatus located in a first gaming venue and connected to said network, said first gaming apparatus including a sports and race wagering ticket acceptor for reading a winning sports and race ticket to establish a wagering credit;
an indicia chosen from the group consisting of a TITO voucher, a wagering account credit, and a loyalty account credit associated with said first gaming apparatus and indicating an amount of said wagering credit, the indicia received other than through a gaming session;
a second gaming apparatus located in a second gaming venue and configured for placing a wager, said second gaming venue being different from said first gaming venue;
said second gaming apparatus including a second device, connected to said network and including a card reader and a bill validator for reading said indicia, operative to establish a wagering credit at said second gaming apparatus;
and
said indicia is used to fund said wager.

4. The system according to claim 3 wherein at least one of said first and second device comprises a kiosk.

5. The system according to claim 3 wherein at least one of said first or second device includes a TITO voucher acceptor.

6. (canceled)

7. The system according to claim 3 wherein at least one of said first or second device includes a player loyalty card acceptor.

8. The system according to claim 3 wherein at least one of said first or second device includes a wagering account login mechanism.

9.-12. (canceled)

13. The system according to claim 3 further including:
a third gaming apparatus in a third gaming venue and connected to said network, said third gaming venue being different from said second gaming venue;
a second indicia associated with said second gaming apparatus, the second indicia indicating the amount of said wagering credit remaining after completion of a gaming session at said second gaming apparatus; wherein
said second indicia may be used to fund a second wager.

14. The system of claim 3 wherein said first gaming apparatus and said second gaming apparatus are electromagnetically connected in a network.

15. A method for placing a wager in one of a plurality of gaming venues selected from among the following types of gaming venues: gaming machines; table games; and race/sports book; said method comprising the steps of:
funding a wagering credit with a winning sports and race wagering ticket at a first type of said gaming venues through a first device including a sports and race wagering ticket acceptor associated with a computer in a gaming establishment network;
obtaining, without placing a wager, indicia from said first type of gaming venue representing the value of said wagering credit, said indicia chosen from the group consisting of a TITO voucher, a wagering account credit, and a loyalty account credit; and
utilizing said indicia in a second device associated with said computer to place a wager in a second type of said gaming venues, said second type of gaming venue being different from said first type of gaming venue and said second device including a card reader and a bill validator for reading said indicia.

16. The method according to claim 15 further including the steps of:
obtaining a second indicia from said second type of gaming venue representing the value of said wagering credit after completion of said wager; and
utilizing said second indicia to place a wager in a third type of said gaming venues, said third type of gaming venue being different from said second type of gaming venue.

17. The method according to claim 15 wherein said gaming venues are located in multiple gaming establishments.

18.-19. (canceled)

20. The method according to claim 15 wherein said step of funding a wagering credit includes providing cash.

21. The method according to claim 15 wherein said step of funding a wagering credit includes providing a TITO voucher.

22. The method according to claim 15 wherein said step of funding a wagering credit includes providing a winning WIN ticket.

23. The method according to claim 15 wherein said step of funding includes using a wagering or loyalty account balance.

24. The method according to claim 15 wherein said first type of gaming venue is a slot machine.

25. The method according to claim 15 wherein said second type of venue is a race/sports book.

26. A method for placing a race/sports book wager utilizing a mobile electronic device comprising the steps of:
electronically accessing race/sports book wagering information on said mobile electronic device through a gaming establishment network;
electronically accessing a player account from said gaming establishment network on said mobile electronic device;
funding a wagering credit from said player account without placing a wager on said mobile electronic device;
displaying an electronic voucher from said gaming establishment on said mobile electronic device;
printing said voucher at said gaming establishment; and
utilizing said printed voucher to place said race/sports book wager.

27. The method of claim 26 wherein said player account is a loyalty account.

28. The method of claim 26 wherein said player account is a wagering account.

29. The method of claim 26 wherein said voucher is a TITO ticket.

30. (canceled)

31. The method of claim 1 wherein said sports and race wagering ticket includes a WIN Ticket.

32. The system of claim 3 wherein said sports and race wagering ticket includes a WIN Ticket.
